(19) United States
(12) Patent Application Publication
(10) Pub. No.: US 2004/0078682 A1
(43) Pub. Date: Apr. 22, 2004

(54) Operating system based method and computer program for monitoring and notifying computer hardware status

(76) Inventor: Jaw-Shiang Huang, (US)

Correspondence Address: MARCUS G THEODORE, PC, 466 SOUTH 500 EAST, SALT LAKE CITY, UT, 84102, US

(21) Appl. No.: 10/246,921

(22) Filed: Sep. 19, 2002

(51) Int. Cl. G06F 11/00

(52) U.S. Cl. 714/37

(57) ABSTRACT

A computer implemented method and program product of an operating system based software program for monitoring normal computer hardware status in operation and notifying of abnormal computer hardware modes to alert system manager comprising First acquiring a virtual memory storage location by a pertained computer system when its operating system boots up, reserving the allocated virtual memory storage, switching to protect mode, and booting BIOS driver in the operating system. Second, the operating system based software program registers a callback function defined by a set of system defined OEM functions to check the existence of the software program, retrieve the address of hardware status and hardware mapping status, acknowledge and process the change of hardware status, and return back to the operating system. Third, the operating system displays the hardware status information controlled by the operating system based software program to report to system managers or users.

### BACKGROUND OF THE INVENTION

1. Field

The present invention relates generally to integrating computer servers for hardware management and related computer programs. More particularly, it relates to a computer implemented method and program product for monitoring normal computer hardware status in operation and notifying of abnormal computer hardware modes to alert system managers.

2. State of the Art

Traditionally, monitoring the hardware status in an integrated computer server system is the task of a system manager. Usually, the system, manager is a systems engineer who is an expert in the use of the Basic Input/Output System (BIOS) functions and writes specified programs to maintain the status of the particular hardware of the computer system. Normally, BIOS functions can be interfaced with an operating system to exchange and transfer data between a computer and its peripherals. In order to monitor the proper functioning of hardware components in the system, a system manager needs to develop a software program based on system defined BIOS functions and particular hardware provided interface instructions. The software program is developed in a computer operating system by defining a set of BIOS interface functions that provide a communication protocol between hardware and operating system software, a software program for driving the defined BIOS interface functions or a BIOS driver based on the defined BIOS interface function, and an utility application program for hardware status report. The utility application program is to combine utilities such as a browser in HTML form, internet servers that support specially formatted documents, email and so forth for the presentation of hardware status notification.

A typical operating system based software system structure for monitoring hardware status is illustrated in FIG. 1. Basically, the system structure consists of a plurality of hardware drivers based on each particular hardware status to be monitored. The hardware drivers are implemented based on either particular hardware defined BIOS functions or hardware status registers to define a set of BIOS interface functions under the control of a computer operating system. A hardware driver is an event-driven object, every time when a hardware status changes it detects an interrupt signal and processes the report of the hardware status change accordingly. It then reports the hardware status change to outside application software products available for the display of messages of the status changes. In order to send hardware status change messages to outside application programs, the operating system based software program installs a set of user-defined interface protocol commands for communicating the processed results obtained from each particular hardware driver to the outside application programs. FIG. 2 illustrates another example of traditional operating system based system structure for monitoring the hardware status in a computer server system with more than one operating system.

Ordinary, a system manager monitoring BIOS functions employs a software program to track the internal hardware status of a computer system. These software programs check if every piece of the hardware is operating normally, and monitors related variables such as the temperature of the central processing unit (CPU), memory error correcting code (ECC) count errors, and withdrawing of hardware disks. Most existing computer systems, such as an appliance server using a personal computer as a system server, require hardware monitoring and notification programs to assure the achievement of a high reliability system operation.

The disadvantage of the present approach is that the system engineer has to develop a new program using the system provided BIOS functions every time a new hardware component is installed. It requires considerable effort to develop a new driver, which is costly and time consuming. In addition there may be cross-platform problems regarding BIOS functions managed by different hardware devices; particularly where a program does not have the capability of notifying the system manager, which one is functioning abnormally, where the hardware devices are not under the same control program.

To provide automatic server system management, a need exists for an operating system based method and computer program, for automatic monitoring and notifying of the hardware status of a computer server system no matter which platform is employed for its base operating systems.

### SUMMARY OF THE INVENTION

The present invention pertains to an operating system based method and computer program for automatically monitoring and notifying a user of the hardware status of a computer system. The operating system based software program is able to connect to an operating system of a computer system, directing the operating system to allocate a virtual memory location for mapping hardware status. This reserves the allocated location to prevent alien attacks, and switches to a protect mode before entering into the operating system based software program. The mechanism of the operating system based method is to check if the machine has been installed with the operating system based software program correctly. Then it assigns the physical address memory block and determines the associated hardware status in the predefined virtual memory table. The program then registers a callback function for understanding and processing status changes.

In accordance with one aspect of the present invention, the method of allocating a virtual memory location is to change the initialization procedure of operating system for a virtual memory table. The method of reserving a virtual memory location is to change the entry setting of the virtual memory map. Whether the machine is installed with the defined BIOS interface functions can be established by checking a magic number stored in the software program.

In accordance with another aspect of the present invention, the method of getting the physical address memory block is to alter the access of the virtual memory mapping table of the operating system so that the access to the hardware status can be obtained by virtual addressing.

In accordance with yet another aspect of the present invention, the method of registering a callback function for understanding whether a hardware status has been changed is to use the polling or interrupt mechanism to trigger the registered callback function. In a preferred embodiment of the method, an example for implementing a registered callback function using the original equipment manufacturer (OEM) functions described in the advanced power management (APM) of operating system is illustrated.

In accordance with a further aspect of the present invention, the operating system based software program can manage the status of various hardware items controllable by software system. Such items monitored include, but are not limited to the temperature of the CPU according to the frequency of its use, the removal of hard disks, and the input and output access to already removed hard disks, and so forth.

Specifically, the invention comprises a computer operating system based method and computer program connected to a computer operating system with hardware and memory storage for automatically monitoring hardware normal status and notifying of abnormal status for the purpose of maintaining computer-related hardware systems. The method is accomplished by: 1) allocating, via the computer operating system, a virtual memory table entry location for mapping the hardware status, 2) reserving, by the computer operating system, the virtual memory table entry allocation for preventing any alien attacks; 3) switching, by the computer operating system, to a protect mode and booting and initializing the BIOS driver into the computer operating system; 3) checking, by the operating system based software program, if the computer hardware is installed with the defined BIOS functions interface to the operating system of the computer hardware; and if not, then returning to normal operation of the operating system; 4) retrieving, by the operating system based software program, the physical address of hardware status and hardware mapping status from the information of the allocated virtual memory; 5) registering, by the operating system based software program, a callback function for acknowledging and processing the change of hardware status; and 6) returning, by the operating system based software program, to normal operation of the operating system.

The first step of allocating virtual memory table entry based on a predefined virtual memory mapping table preferably is automatically performed without user intervention and further comprises a step of altering said particular mapping route to change the function of initialization of the operating system.

The second step of reserving virtual memory location based on the predefined virtual memory mapping table preferably includes a step of routing said particular mapping entry setting to assure the physical memory pages are always continuous in associated with the virtual memory entries.

The third step of checking the existence of the defined BIOS interface functions after the operating system is switched to the protect mode and performed its normal booting procedure preferably includes a step of comparing a magic number to identify the successful installation of the operating system based software program.

The fourth step of retrieving the physical address of the hardware status may include a step of altering the size of the memory block and the linear address of the memory block in the protect mode of the computer operating system. This step may further include relating the physical address to the virtual memory address defined in the virtual memory mapping table where the hardware status was stored.

The fifth step of registering a callback function for acknowledging and processing the change of the hardware status may include a step of notifying the operating system based software implemented program with a message that the hardware status has already been changed. This step may further include installing in the callback function a function to check which hardware status has been changed, recording the changed hardware status, notifying of the hardware status changes, and avoiding unusual and abnormal hardware actions, if necessary. This step of avoiding unusual and abnormal hardware actions generally only pertains to those pieces of equipment controllable by the software system exclusively, such as the reduced temperature of a CPU by reducing the frequency use of the CPU, the withdrawing of hard disks, and the input and output actions of file systems to a non-existing hard disk. Notifying of the hardware status reports generally includes notification by Log record, email, ICQ, or phone message on cellular panel. The hardware status reports are generally viewed via a serial console or monitor, or through internet from remote site of the computer system.

The method is generally accomplished with a computer program product for use in conjunction with an operating system for a network attached storage hardware platform of any scale. The computer product embedded in a computer readable storage medium with a computer program procedure. The computer program procedure comprises a program module that directs an operating system based software program connected to the operating system to function in a specified manner. Preferably, the program procedure includes a startup procedure having instructions with the capability to a) allocate a virtual memory location for mapping hardware status after the operating system is booted, b) switch the operation system to a protect mode, and c) enter into the operating system based software program. This startup procedure usually includes instructions having the capability to use the defined BIOS functions for defining the interface between the operating system based software program and the operating system. These instructions include:

a. a polling or interrupt mechanism for getting the inquiry of the operating system based software program if the hardware status has been changed;

b. an Installation Check for identifying the existence of the operating system based software program;

c. a Get Exchange Data Block for specifying the physical address of where to store the hardware status information; and

d. a Get Hardware Status for obtaining the updated hardware status information.

The Get Hardware Status procedure to obtain the updated hardware status information includes CPU thermal status, memory ECC count, hard disk status, fan fault status, power supply fault status, battery status, and battery fault status.

In another embodiment, the embedded media computer program product for use in conjunction with an operating system for a network platform of any scale comprises a program module that directs an operating system based software program connected to the operating system to function in a specified manner. The program procedure includes a notification procedure with instructions having the capability to notify a user or a system manager of a change in hardware status and to present all of the hardware status information through a user-interface of the system. The notification of the user includes sending by email or by Log record. In this variation, a system manager is allowed to fill in the specification of an SMTP server and email address.

In another embodiment, of the computer program product embedded in a computer readable storage medium with a program procedure comprises a program module that directs an operating system based software program connected to the operating system to function in a specified manner. This includes a monitoring procedure with instructions having the capability to look up a user-interface via a callback function to detect and record a result as to which hardware status has been changed and to avoid unusual and abnormal hardware actions, if necessary. Preferably, the recorded monitoring user-interface result is presented in three seconds intervals through a browser in HTML form.

In another preferred embodiment, the computer readable storage medium that directs an operating system based software program is connected to an operating system that creates a location of virtual memory mapping table. Its entries point to continuous physical memory pages, and has a protection procedure including instructions with a capability to protect by the operating system all programs stored in the virtual memory mapping table from any sort of alien attacks. The instructions of this protection procedure include the use of the defined BIOS interface functions to define protocols for communication of detected hardware information of the BIOS driver. This enhances its power and optimizes the functionality and capability of the BIOS driver and associated hardware.

Thus, the above operating system based method and computer program, provides for automatic monitoring and notifying of the hardware status of a computer server system no matter which platform is employed for its base operating systems

### BRIEF DESCRIPTION OF THE DRAWINGS

FIG. 1 illustrates an example of a general operating system based software system structure for reporting hardware status of a single computer system.

FIG. 2 illustrates another example of a general operating system based software system structure for reporting hardware status of more than one computer systems.

FIG. 3 illustrates another example of a general operating system based software system structure for reporting hardware status of a computer system in accordance with the present invention.

FIG. 4 illustrates another example of a general operating system based software system structure for reporting hardware status of more than one computer system in accordance with the present invention.

FIG. 5 illustrates a block diagram depicting a general procedure of the present invention.

FIG. 6 illustrates a flowchart depicting a general procedure for monitoring hardware status and notifying hardware status change.

FIG. 7(a) illustrates a program module of OEM function 1 of the present invention.

FIG. 7(b) illustrates a program module of OEM function 2 of the present invention.

FIG. 7(c) illustrates a program module of OEM function 3 of the present invention.

FIG. 7(d) illustrates a program module of OEM function 4 of the present invention.

FIG. 8(a) illustrates a screen shot of the operating system based software implemented hardware status notification by email.

FIG. 8(b) illustrates another screen shot of the operating system based software implemented hardware status notification by email.

FIG. 8(c) illustrates an example of a screen shot of a systems log generated by the operating system based software program.

FIG. 8(d) illustrates another example of a screen shot of a systems log generated by the operating system based software program.

FIG. 9(a) illustrates an example of a screen shot produced by the operating system based software program in monitoring the hardware status of the CPU presented by a browser in hypertext markup language (HTML) format.

FIG. 9(b) illustrates another screen shot produced by the operating system based software program in monitoring the fans presented by a browser in HTML format.

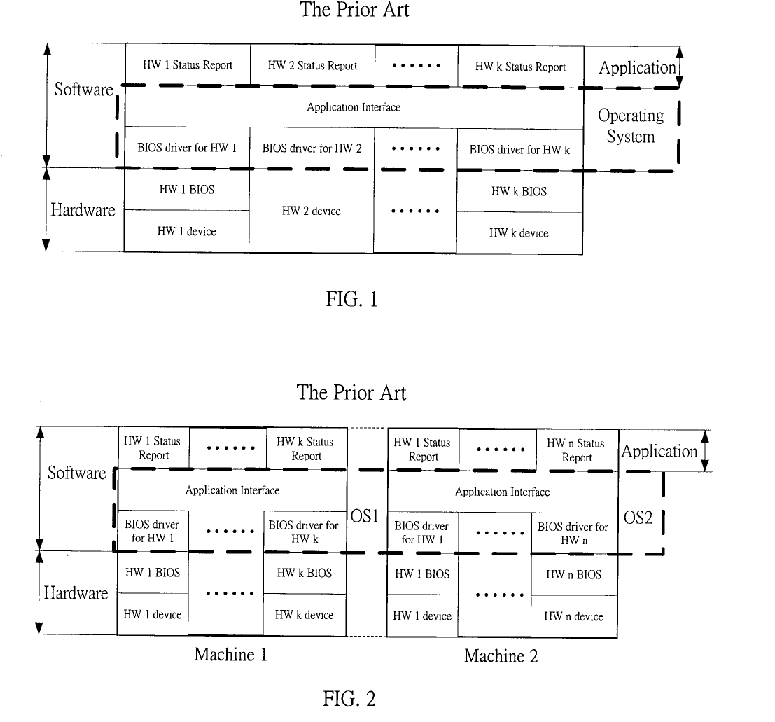

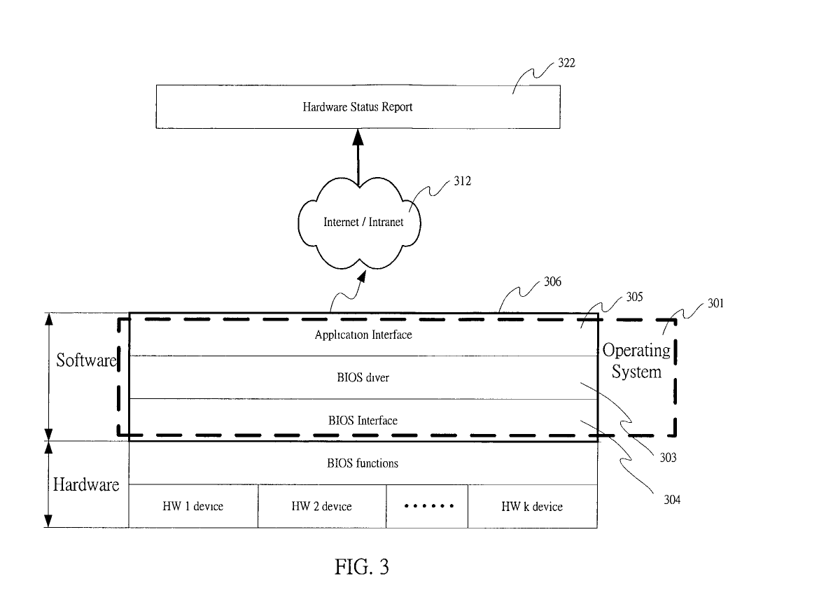

### DETAILED DESCRIPTION OF THE PREFERRED EMBODIMENTS OF THE INVENTION

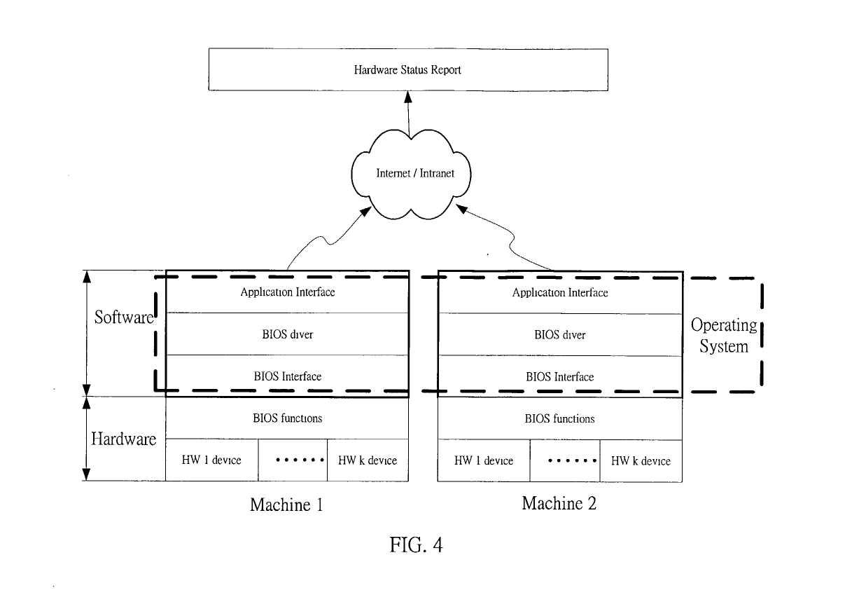

The method comprises an operating system based software program generally connected to an operating system to interface the operating system and components of a computer system. If the software program is used for a purpose in monitoring the normal operations and notifying a system manager the abnormal operations of the hardware status of the system components, then the software implemented program is a hardware status reporter in the management of a computer server system. The idea of the present invention is shown in FIGS. 3 and 4. FIG. 3 illustrates the operating system based software system structure of the present invention for reporting hardware status under an operating system. FIG. 4 illustrates the same operating system based software system structure used for reporting hardware status under two different operating systems.

As shown in FIG. 3, the operating system based software program 306 of the present invention installed in a computer operating system 301 consists of a BIOS driver 303, a BIOS interface 304, and an application interface 305. The BIOS interface 304 is used to connect to the defined BIOS functions in a hardware platform to get hardware status when the operating system 301 boots up. The BIOS driver 303 is used to detect what hardware status has been changed and understand how each hardware status change should be reported. The application interface 305 is used to connect to outside application programs for the report of the process result of the BIOS driver 303. This may be done through an intranet or internet communication 312 to outside application programs 322 for hardware status reports.

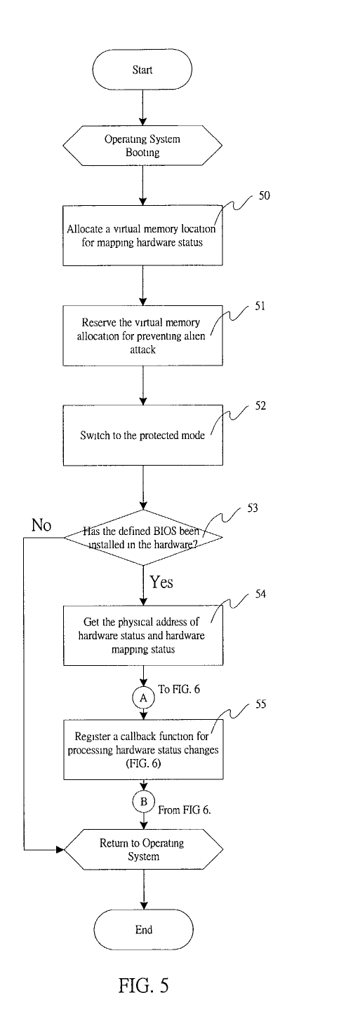

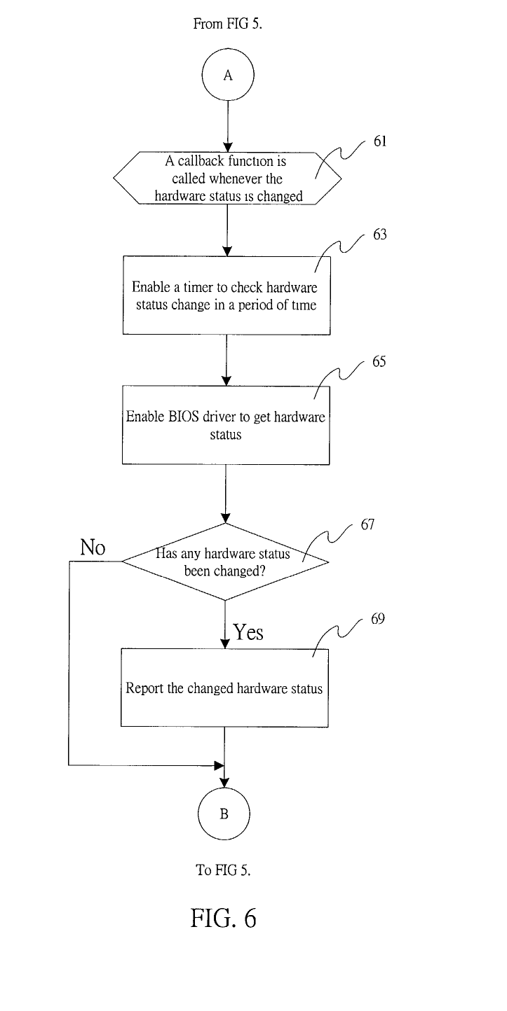

FIG. 5 is a flowchart describing the steps pertaining to the present invention for monitoring normal hardware status and notifying of abnormal hardware status changes. As shown in Block 50 of the FIG. 5, the method is to allocate a virtual memory location for mapping the hardware status once the operating system is booting up.

Conventional means use hardware registers to transfer hardware status data, this causes busy transmission of small amount of data between hardware BIOS and the computer operating system. Instead, in a preferred embodiment of the present invention, the software means are employed to create a memory area for transferring hardware status data. This can be done by allocating the physical address of 0×00000000˜0×00100000 of a personal computer system, a memory area having not been used by the management of an operating system, as a virtual memory mapping table for transferring hardware status data between hardware BIOS and operating system. As shown in the Block 51, the system then reserves the allocated virtual memory location allowing the system to prevent any sort of alien attacks to the area. Because the virtual memory mapping table entries point to continuous concatenated physical memory pages, as shown in the Block 52, the operating system then switches to the protect mode, allowing the reserved area for sole use by the APM driver or the driver program of the operating system based software program to process hardware status. As shown in the Block 53, the operating system 301 then surrenders its power to the operating system based software program 306 if the system is installed with the software program. Otherwise the operating system will reclaim back its power for systems operations. As long as the operating system based software program 306 gains its power, as shown in the Block 54, the software program begins to get the physical address of hardware status and predefined hardware mapping status stored in the virtual memory table. As shown in the Block 55, the operating system based software program 306 then starts to register a callback function for the process of hardware status change by a polling check at a preset time period. It finally returns to the normal operating system 301 to repeat the same monitoring and notifying process again.

Referring to FIG. 6, in order to detect the hardware status information for hardware status monitoring and notifying purposes as shown in FIG. 5 Block 55, the operating system based software program 306 starts to register a callback function, as shown in FIG. 6 Block 61, to perform the task. In general, a callback function is defined by a set of system defined OEM functions. By adding the callback function to a system APM driver, not only is the power of original APM driver enhanced, but also the capability to detect the hardware status for a more powerful system management.

In processing the detection of hardware status, as depicted in the Block 63 of FIG. 6, first the callback function is installed in the BIOS driver 303 to enable a timer to detect whether there is any hardware status change from time to time. As shown in the Block 65, the BIOS driver 303 then retrieves the hardware status information currently stored in a predefined virtual memory table. The process to generate the hardware status information consists of putting the currently detected hardware status into a memory block first and then getting the obtained hardware status from the address corresponding to the memory block later. As shown in the Blocks 67 and 69, the BIOS driver 303 reports the information of hardware status change or no hardware status change to the callback function for further processing.

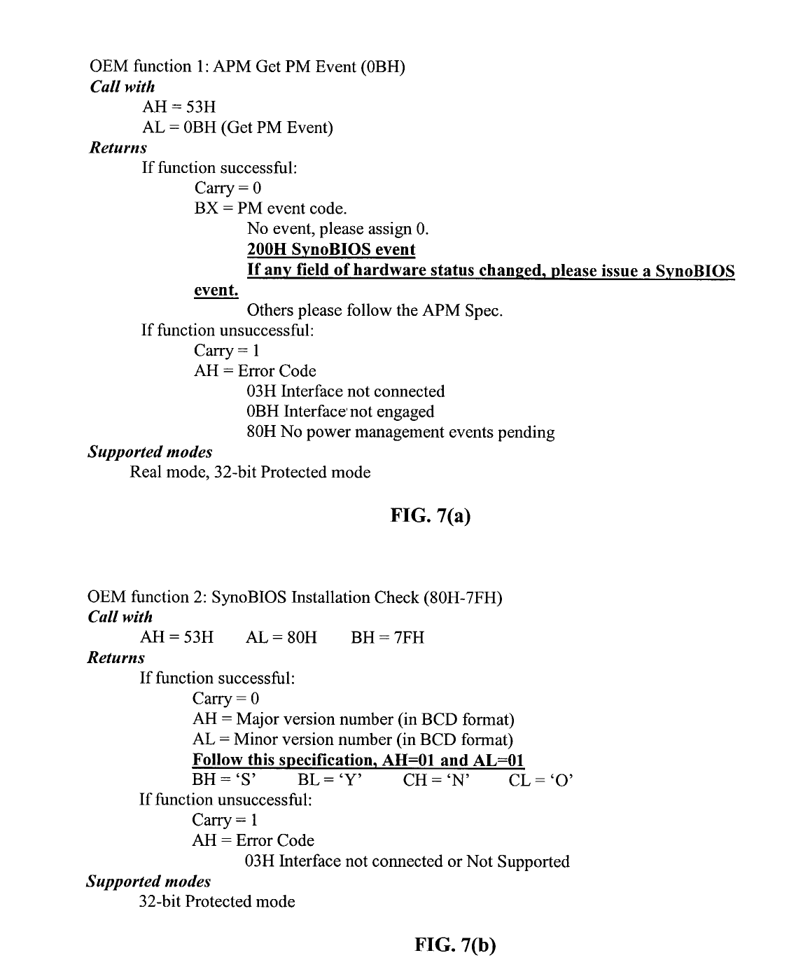

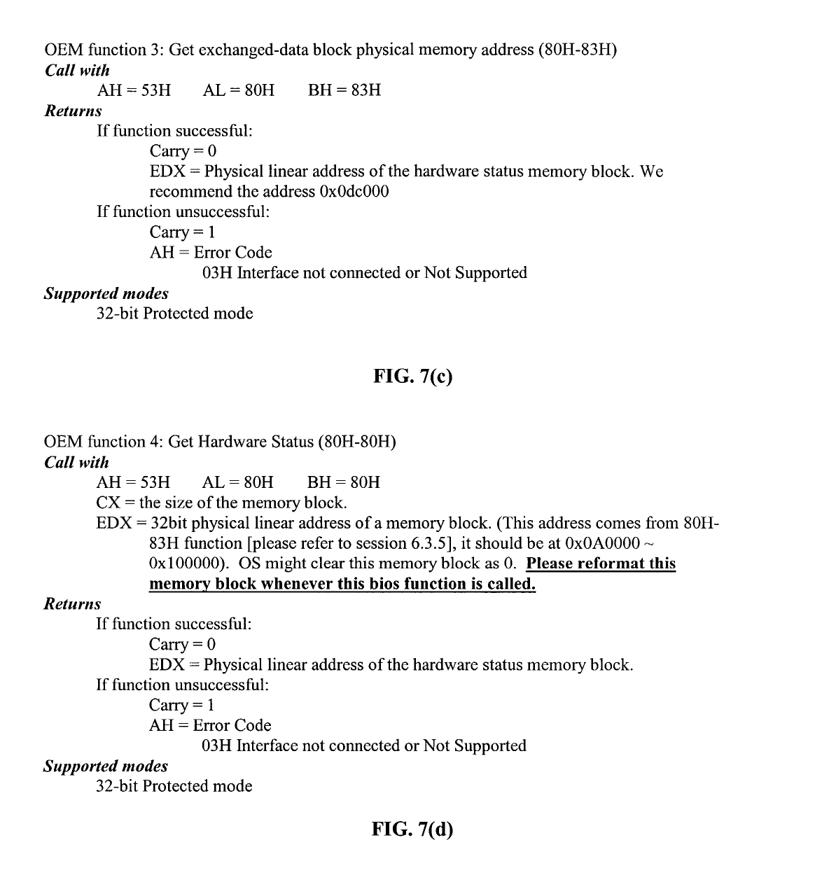

FIG. 7 illustrates some OEM functions defined in the callback function. FIG. 7(a) shows a get-physical-memory event OEM function being defined, in which the BIOS specified APM polling function is used to inquire if the BIOS hardware status has been changed. If any field of hardware status has been changed, then the function issues a message to indicate such an event change. Otherwise a message of no change to the operating system based software program 306 is provided for further process. FIG. 7(b) is an OEM function to check if the software program exists in the machine. This OEM function generates a message or a special code to indicate a successful or unsuccessful installation of the operating system based software program 306 in the machine concerned. FIG. 7(c) shows another OEM function that is used to get exchanged-data-block physical memory addresses. In this process, the currently detected hardware status is put into a memory block. FIG. 7(d) is an OEM function designed to reflect the hardware status just being put in the memory block. Each hardware status of an item consists of three fields for storing data: object identification, object data length, and value of the item. These items include: CPU thermal status, memory ECC count, hard disks withdrawing status, power supply status, fan operation status, battery power level status, battery fault status, and so on.

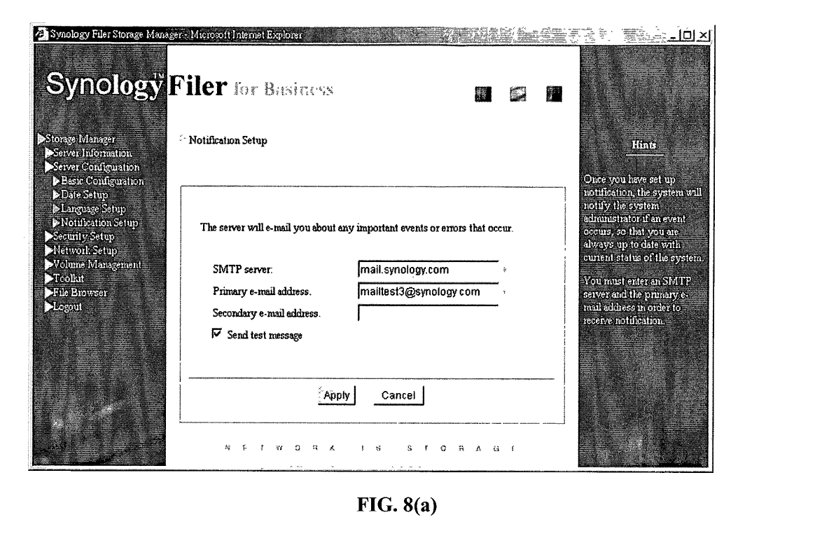

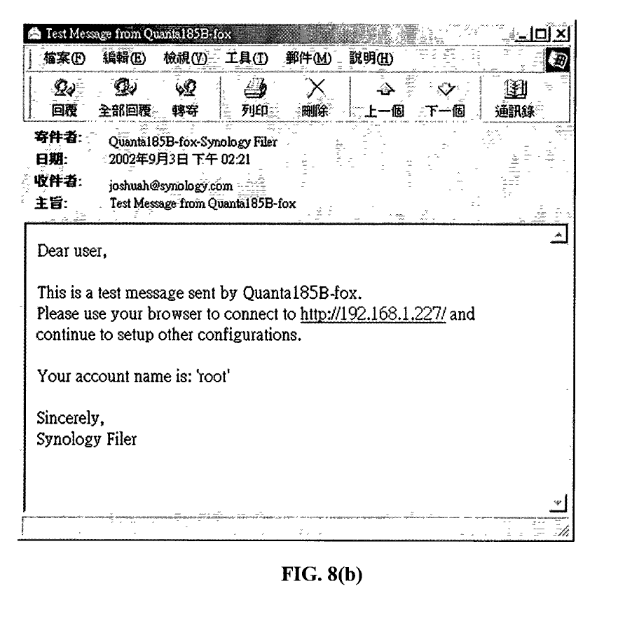

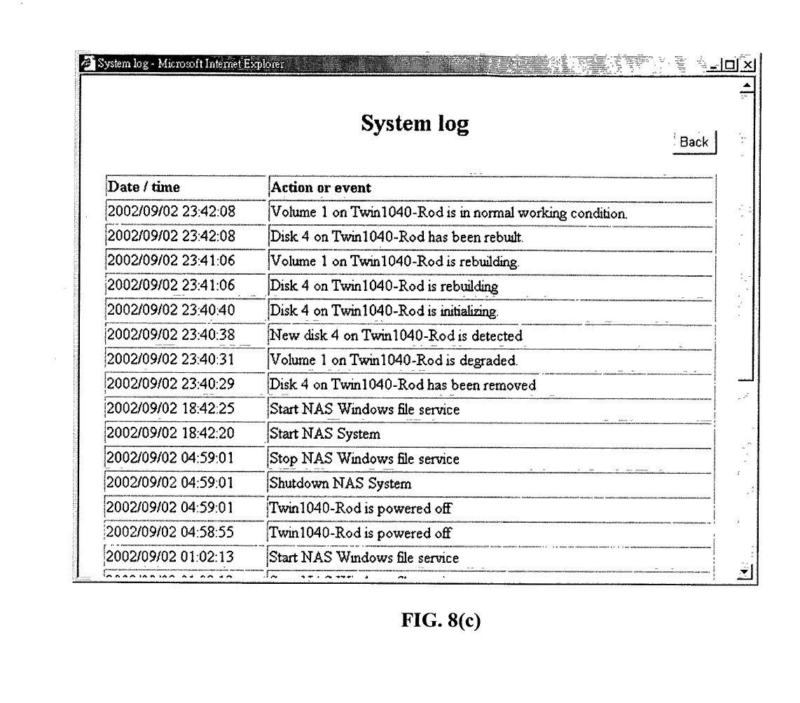

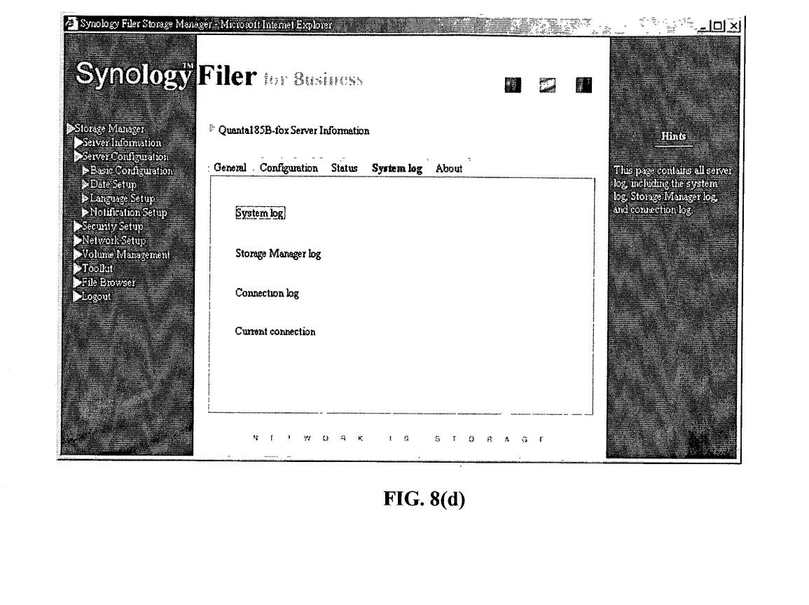

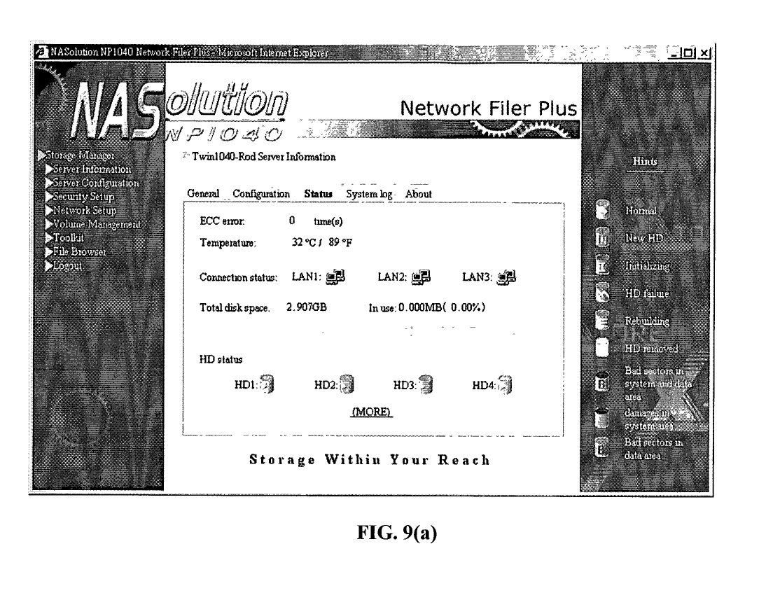

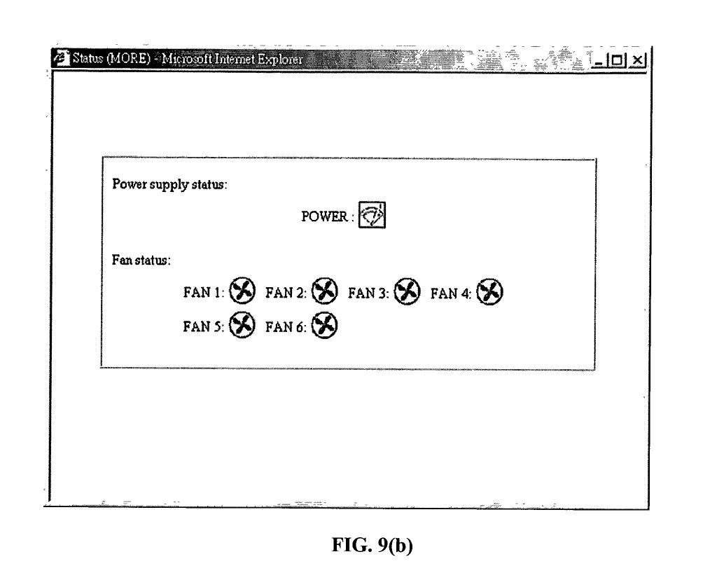

Once the relationship between the operating system 301 and its BIOS driver 303 has been completely defined, all hardware status information can be fully controlled by the operating system 301. The normal operation of an operating system can display the hardware status information controlled by the operating system based software program 306, through the application interface 305 to system managers or users. Referring to FIGS. 8(a) and (b), usually, the presentation of hardware status notification is by sending email such as the two examples shown in FIGS. 8(a) and 8(b) or by ICQ or cellular phone panel messages to system managers or users. Alternatively, a systems log such as the two examples shown in FIGS. 8(c) and 8(d) may be used. As far as the monitoring of computer hardware status is concerned, the report of each monitoring state may be presented in HTTP format through a system of internet servers that support specially formatted documents, or by the global information network interfacing to multiple users and managers. For example, the easy-to-use online instant messaging program ICQ developed by Mirabilis LTD or America On Line's popular Buddy List and Instant Messenger programs may be utilized to transmit and receive data. FIGS. 9(a) and 9(b) show two examples of illustrative screen shots indicating the hardware status for monitoring.

While the invention has been illustrated and described in detail in the drawings and foregoing description, it is not hard for ordinary skilled persons in the art to modify the disclosed method of the present invention, it being understood that only the preferred embodiment thereof have been described and that all changes and modifications that come within the spirit of the invention are desired to be protected. Nor is it intended by the above description to narrow the scope of the appended claims. The claims themselves recite those features deemed essential for the invention.

I claim:

1. A computer-implemented method of an operating system based software program connected to a computer operating system with hardware and memory storage for automatically monitoring hardware normal status and notifying of abnormal status for the purpose of maintaining computer-related hardware systems, the method comprising the steps of:
a. allocating, by the computer operating system, a virtual memory entry location for mapping the hardware status;
b. reserving, by the computer operating system, the virtual memory entry allocation for preventing any alien attacks;
c. switching, by the computer operating system, to protect mode and booting the BIOS driver into the computer operating system;
d. checking, by the operating system based software program, if the computer hardware is installed with the software program interfaced to the operating system of the computer hardware; and if not, then returning to normal operation the operating system;
e. retrieving, by the operating system based software program, the physical address of hardware status and hardware mapping status from the information of the allocated virtual memory entry;
f. registering, by the operating system based software program, a callback function for acknowledging and processing the change of hardware status; and
g. returning, by the operating system based software program, to normal operation of the operating system.

2. The method of claim 1, wherein said step of allocating virtual memory table entry based on a predefined virtual memory mapping table is automatically performed without user intervention and further comprises a step of altering said particular mapping route to change the function of initialization of the operating system.

3. The method of claim 1, wherein said step of reserving virtual memory location based on the predefined virtual memory mapping table further comprises a step of routing said particular mapping entry setting to assure the physical memory pages are always continuous in associated with the virtual memory entries.

4. The method of claim 1, wherein said step of checking the existence of the operating system based software program after the operating system is switched to the protect mode and performed its normal booting procedure further comprises a step of comparing a magic number to identify the successful installation of the operating system based software program.

5. The method of claim 1, wherein said step of retrieving the physical address of the hardware status further comprises a step of altering the size of the memory block and the linear address of the memory block in the protect mode of the computer operating system.

6. The method of claim 5, wherein said step of retrieving the physical address of the hardware status further comprises a step of relating the physical address to the virtual memory address defined in the virtual memory mapping table where the hardware status was stored.

7. The method of claim 1, wherein said step of registering a callback function for acknowledging and processing the change of the hardware status further comprises a step of notifying the operating system based software program with a message that the hardware status has already been changed.

8. The method of claim 7, wherein said step of registering a callback function for acknowledging and processing the change of the hardware status further comprises: installing in the callback function a function to check which hardware status has been changed, recording the changed hardware status, notifying of the hardware status changes, and avoiding unusual and abnormal hardware actions, if necessary.

9. The method of claim 8, wherein said step of avoiding unusual and abnormal hardware actions pertains to only those controllable by the software system exclusively.

10. The method of claim 9, wherein the unusual and abnormal hardware actions include those items that can be controlled by the software system, such as the reduced temperature of a CPU by reducing the frequency use of the CPU, the withdrawing of hard disks, and the input and output actions of file systems to a non-existing hard disk.

11. The method of claim 8, wherein the step of notifying the hardware status reports includes notification by market provided services such as Log record, email, ICQ, or phone message on cellular panel, as to the hardware status via reports viewed through a serial console or monitor, or through internet from remote site of the computer system.

12. A computer program product for use in conjunction with an operating system for a bus interfaced system hardware platform, with devices for computing and storing of any scale, the computer product embedded in a computer readable storage medium with a computer program procedure, said computer program procedure, comprising: a program module that directs an operating system based software program connected to the operating system to function in a specified manner, the program procedure including:
a startup procedure having instructions with the capability to allocate a virtual memory location for mapping hardware status after the operating system is booted, to switch the operation system to a protect mode, and to enter into the operating system based software program.

13. The computer program product of claim 12, wherein the startup procedure includes instructions having the capability to use the defined BIOS interface functions between the operating system based software program and the operating system, said instructions including:
a. a polling or interrupt mechanism for getting the inquiry of the operating system based software program if the hardware status has been changed;
b. an Installation Check for identifying the existence of the operating system based software program;
c. a Get Exchange Data Block for specifying the physical address of where to store the hardware status information; and
d. a Get Hardware Status for obtaining the updated hardware status information.

14. The computer program product of claim 13, wherein the Get Hardware Status procedure for obtaining the updated hardware status information includes items that can be monitored by a software program, such as CPU thermal status, memory ECC count, hard disk status, fan fault status, power supply fault status, battery status, and battery fault status.

15. A computer program product for use in conjunction with an operating system for a bus interfaced system platform, with devices for computing and storing of any scale having hardware with memory storage embedded in a computer readable storage medium and a program procedure, comprising: a program module that directs an operating system based software program connected to the operating system to function in a specified manner, the program procedure including a notification procedure with instructions having the capability to notify a user or a system manager of a change in hardware status and to present all of the hardware status information through a user-interface of the system.

16. The computer program product of claim 15, wherein the notification to the user includes market provided services such as sending by email or by Log record and a system manager is allowed to fill in the specification of an SMTP server and email address.

17. A computer program product for use in conjunction with an operating system with a bus interfaced system hardware platform, with devices for computing and storing of any scale, having hardware with memory storage embedded in a computer readable storage medium with a program procedure; said computer program procedure comprising: a program module that directs an operating system based software program connected to the operating system to function in a specified manner, and including a monitoring procedure with instructions having the capability to look up a user-interface via a callback function to detect and record a result as to which hardware status has been changed and to avoid unusual and abnormal hardware actions, if necessary.

18. The computer program product of claim 17, wherein the recorded monitoring user-interface result is presented in three seconds intervals through a market provided displaying means including a browser in HTML form.

19. A computer readable storage medium that directs an operating system based software program connected to an operating system created location of virtual memory mapping table with its entries pointing to a continuous physical memory pages, comprising: a protection procedure including instructions having a capability to protect by the operating system all programs stored in the virtual memory mapping table from any sort of alien attacks.

20. The computer readable storage medium of claim 19, wherein the instructions of the protection procedure include the use of a Basic Input and Output System (BIOS) provided functions, such as some APM OEM functions to define protocols for communication of detected hardware information of the APM driver to enhance its power and optimize the functionality and capability of the APM driver and associated hardware.
